(19) United States
(12) Patent Application Publication
(10) Pub. No.: US 2025/0284765 A1
(43) Pub. Date: Sep. 11, 2025

(54) Method and Device for Efficiently Operating a Neural Network with Convolutions

(71) Applicant: Robert Bosch GmbH, Stuttgart (DE)

(72) Inventors: Sebastian Boblest, Duernau (DE); Benjamin Wagner, Friedrichshafen (DE); Duy Khoi Vo, Stuttgart (DE); Leif Sulaiman, Lund (SE); Markus Lochmann, Reutlingen (DE); Ulrik Hjort, Malmö (SE)

(21) Appl. No.: 19/057,659

(22) Filed: Feb. 19, 2025

(30) Foreign Application Priority Data
Mar. 5, 2024 (DE) 10 2024 202 064.8

(51) Int. Cl. G06F 17/15

(52) U.S. Cl. CPC G06F 17/15

(57) ABSTRACT

A method is for parallelized calculation of two convolutions of a filter having first and second receptive fields of the filter on input data. The first and second receptive fields correspond to a filter shifted by one step on the input data. The method includes initializing first and second output variables each having an initial value, and executing a loop for each line of the filter. The loop performs loading a first kernel element of the filter of the line and the corresponding data values to the first kernel element of the first and second receptive fields of the input data.

This application claims priority under 35 U.S.C. § 119 to patent application no. DE 10 2024 202 064.8, filed on Mar. 5, 2024 in Germany, the disclosure of which is incorporated herein by reference in its entirety.

The disclosure relates to a method for parallelized calculation of two convolutional operations of a filter, a device, a computer program and a machine-readable storage medium.

### BACKGROUND

Convolutions are one of the most important layers for neural networks. In networks with convolutions (CNNs), these layers typically comprise over 90% of the total time it takes to calculate an inference. Efficient implementations of these are therefore very important and thus an object of this disclosure, in particular an implementation of certain convolutions that are common in modern CNNs, which increases data reuse and thus allows more efficient calculation on microcontrollers.

For more powerful architectures such as GPUs and CPUs, Winograd implementations are very often used that reduce the number of multiplications but use a large amount of RAM. Thus, for hardware platforms with limited RAM, these implementations cannot be used. Instead, a partial Im2Col implementation is used, see for example: K. Chellapilla, S. Puri, and P. Simard. High performance convolutional neural networks for document processing. Tenth International Workshop on Frontiers in Handwriting Recognition, University of Rennes 1, October 2006, La Baule (France), 2006.

### SUMMARY

The disclosure addresses a shortcoming of Im2Col implementation in certain convolution configurations that are very commonly used in modern CNNs. Provided that the dilation is 1 and the stride is smaller than the kernel size, successive lines of the Im2Col buffer contain data in duplicate. At the same time, the data required for calculating an output pixel is already stored line by line in the memory. This can now be used to calculate two output pixels of the convolution without loading duplicate data and thus saving memory bandwidth.

In a first aspect, the disclosure relates to a computer-implemented method for parallelized calculation of two convolutions of a filter having a first and second receptive field of the filter on input data on a data processing system, in particular a microcontroller, with limited computing resources. The filter and the input data are at least two-dimensional (height, width and a number of input channels). A receptive field of a filter in a mathematical convolution refers to the range of the input data to which the filter is applied. It is the range where the filter applies the weights to generate the output. The receptive field may be considered a type of “field of view” of the filter. The receptive field is determined by the size of the filter and the step width (stride). The size of the filter specifies how many input values the filter considers simultaneously, while the step size specifies how far the filter is moved over the input data at each step. Limiting computing resources may relate to the following aspects: With respect to the CPU, in particular how many calculations and operations can be performed, and with respect to a memory/space or bandwidth.

The method starts with initializing first and second output variables (o₀₀₀,o₀₁₀) each having an initial value (b₀), wherein the output variables (o₀₀₀,o₀₁₀) each have a result of the convolution of the filter with the first and second receptive fields. The initial value (b₀) is typically a trained parameter of the neural network.

This is followed by the execution of a loop for each line r with a value range from 0 to the maximum number of filter coefficients of the filter along the dimension of its lines minus the value one. That is, the loop is executed over each line of the kernel matrix of the filter, wherein the loop performs the following steps:
loading a first kernel element k_{r0c} of the filter of the line r and the corresponding data values d_{r0c}, d_{r1c} to the first kernel element (k_{r0c}) of the first and second receptive fields of the input data. The corresponding data values d_{r0c} d_{r1c} to the first kernel element (k_{r0c}) are those data points of the input data to which the first kernel element (k_{r0c}) is to be applied according to the first and second receptive fields.
calculating the value of the first output variable (o₀₀₀) by adding a product of d_{r0c} and k_{r0c} to a current value of the first output variable (o₀₀₀), and calculating the value of the second output variable (o₀₁₀) by adding a product of d_{r1c} and k_{r0c} to a current value of the second output variable (o₀₁₀).
loading the next kernel element (k_{r1c}) of the filter from the corresponding line of the current loop index r. The next kernel element k_{r1c} is the kernel element of the filter immediately following the first kernel element k_{r0c}.
calculating the value of the first output variable (o₀₀₀) by adding a product of d_{r1c} and k_{r1c} to the current value of the first output variable (o₀₀₀).
loading further data values d_{r2c} and d_{r3c}. The further data values d_{r2c} and d_{r3c} are the data values already loaded d_{r0c}, d_{r1c} subsequent data values d_{r2c} and d_{r3c} of the first and second receptive fields, in particular the data values for which the next convolution operation is to be executed with the two following kernel elements k_{r1c} and k_{r2c}.
calculating the value of the second output variable (o₀₁₀) by adding the product of d_{r2c} and k_{r1c} to the current value of the second output variable (o₀₁₀).
   loading the next kernel element k_{r2c}.
calculating the value of the first output variable (o₀₀₀) by adding the product of d_{r2c} and k_{r2c} to a current value of the first output variable (o₀₀₀), and calculating the value of the second output variable (o₀₁₀) by adding the product of d_{r3c} and k_{r2c} to a current value of the second output variable (o₀₁₀).

It should be noted that the method was exemplified for a filter having 3 kernel elements per line. In the event that the filter has 2 or more kernel elements per line, the method can be adjusted accordingly by loading (and calculating) more or fewer kernel elements together with corresponding data values correspondingly in alternating fashion.

Optionally, outputting the second (and/or first) output variable (o₀₀₀, o₀₁₀) may be performed as convolution results for the two convolutions.

After the method has been performed, it may be performed again for the next receptive field of the filter. In particular, the method is performed until the convolution of the filter with the entire input data has been performed. That is to say, until the input data received has been effectively covered by the receptive field.

It is proposed that the filter and the input data have a plurality of channels and another loop is executed for each channel c across the loop over the lines r. The filter and the input data may accordingly each be given as a tensor, preferably with the same number of channels. If the number of channels does not match, the method according to the disclosure can additionally be repeated along the dimension of the channels several times until the receptive field has effectively covered the entire tensor of the input data.

Furthermore, it is proposed that the kernel elements are stored according to a sequence k₀₀₀; k₀₁₀; k₀₂₀; ::: k₁₀₀; k₁₁₀; k₁₂₀; :::. That is to say, the kernel elements were read out line by line and the lines were compiled one after the other to form the sequence in question. This has the advantage that no pointer is required for the sequence of filter elements and only two pointers are needed for efficient processing of the input data.

In further aspects, the disclosure relates to a device and to a computer program, which are each configured so as to carry out the aforementioned methods, and to a machine-readable storage medium on which said computer program is stored.

### BRIEF DESCRIPTION OF THE DRAWINGS

Embodiments of the disclosure are explained in greater detail below with reference to the accompanying drawings. In the drawings:

FIG. 1 schematically shows a representation of a partial Im2Col algorithm for a single output pixel for a convolution with (3×3) kernels without dilation with stride 1;

FIG. 2 schematically shows a representation of the partial Im2Col algorithm for two adjacent output pixels for a convolution with (3×3) kernels without dilation with stride 1;

FIG. 3 schematically shows an illustration for nested implementation of a (3×3) convolution with stride 1; and

FIG. 4 schematically shows pseudocode of an exemplary embodiment of the disclosure.

### DETAILED DESCRIPTION

Partial Im2Col implementation is known from the prior art. For example, 2D convolutions are implemented in this way in the CMSIS-NN library (L. Lai, N. Suda, and V. Chandra. Cmsis-nn: Efficient neural network kernels for arm cortex-m cpus) from ARM.

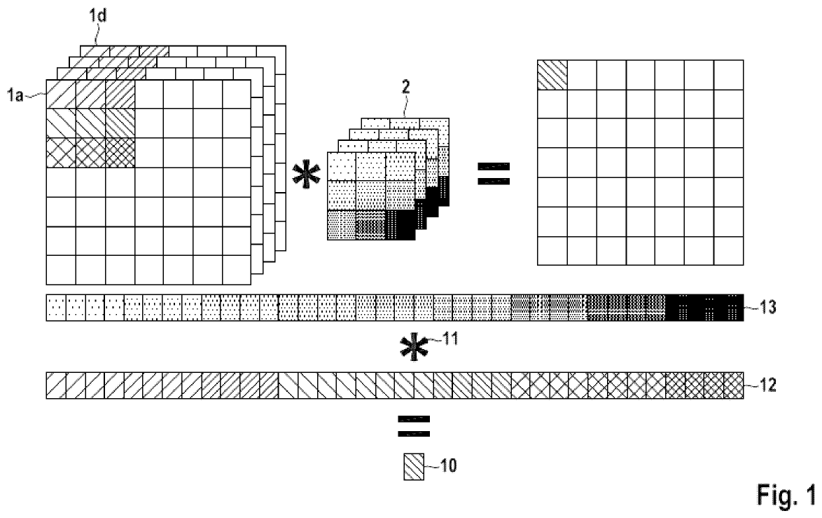

FIG. 1 illustrates the procedure for calculating an output pixel (10) for a convolution (11) having a kernel size (3×3) and stride 1 and dilation 1 according to Im2Col implementation. The input data (1a,1d), which are preferably each present as 2D input data, such as a matrix, is to be convoluted with one or more filters (2).

The data required for one pixel in the output channels is copied sequentially from the input data to another storage area (12). The actual convolution is then a simple scalar product of the values in the kernel with those from the input data. The kernel is already in the right order. In order to use data, in particular kernel elements, several times, the data for several pixels is usually loaded from the input data. In addition, kernel elements are also loaded for multiple output channels (13).

How many pixels are loaded in parallel is a balance between the RAM required for this and the saving of duplicate loading processes for kernel elements and input data. In addition, the number of simultaneously loaded data is also limited by the available registers. A battery variable is required for each output pixel to be calculated in addition to the loaded data, so that the register demand increases very quickly. CMSIS NN, for example, loads the data for two pixels and two output channels, and then only needs to load the kernel data once for these two pixels. Four accumulator variables are then required. This number is adapted to the 13 registers of the Cortex-M architecture.

The use of Im2Col has the advantage that for each kernel size and each value for stride and dilation, the convolution is attributed to a matrix multiplication, which is also very efficient on CPUs compared to a nested loop implementation, which requires the input data to load multiple times.

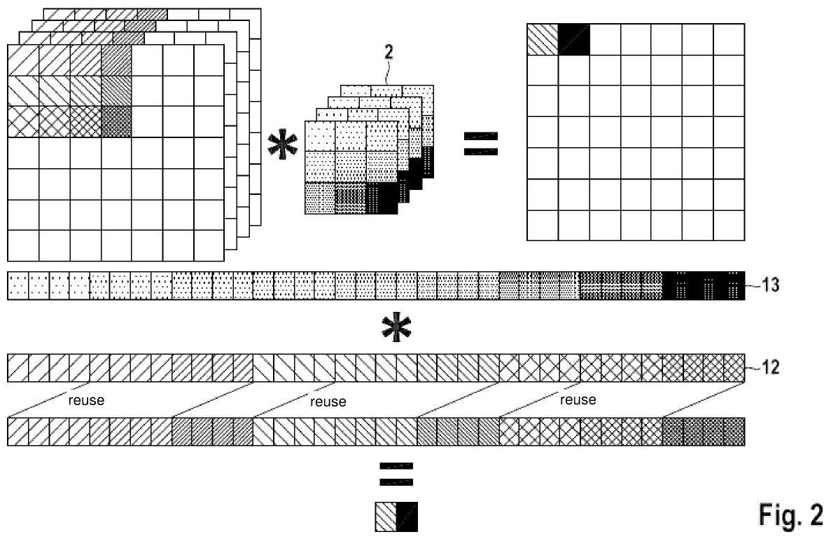

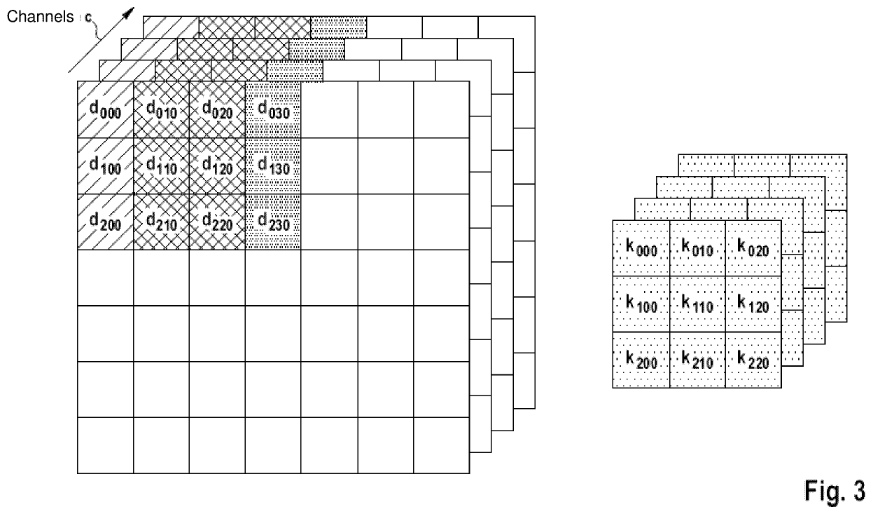

In the following, a shortage of Im2Col implementation is to be addressed for certain convolution configurations that are very commonly used in modern CNNs. Provided that the dilation is 1 and the stride is smaller than the kernel size, successive lines of the Im2Col buffer contain data in duplicate, see FIG. 2. That is to say, if the receptive field of the filter (2) is moved by one step, in FIG. 2 by one position horizontally to the right, for the next convolution after the convolution has been completed, then some of the data from the input data that was already in the receptive field of the filter in the previous step is reloaded into the memory area (12). As the receptive field has moved by one step to the right, only the three superimposed data points to the right of the previous data points in the memory area (12) are really new in the next step. The schematic first and second lines of the memory area (12) thus contain 66% of the data in duplicate without this being exploited in the Im2Col implementation. Instead, this data is loaded multiple times from its original location in memory into the memory area (12). At the same time, the data required for calculating an output pixel is already stored line by line in the memory, see FIG. 3.

The index notation dᵢⱼₖ in FIG. 3 refers to the ith row, jth column and kth input channel. This can now be used to calculate two output pixels of the convolution without loading duplicate data and thus saving memory bandwidth. The highlighted data to the left is used for calculating the output pixels 0 and 1. For each output pixel, the data is already stored line by line in memory. For example, for output pixels o₀₀₀, the data d₀₀₀ to d_{c03} in the first line.

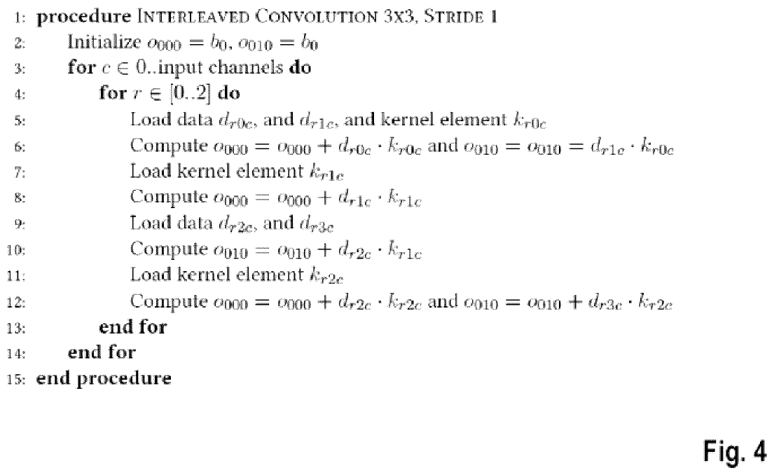

FIG. 4 shows an exemplary computational specification in the form of a pseudo algorithm for resolving said defect. The structure of this calculation takes into account the properties of microcontrollers:

Data is not loaded until it is needed for the next calculation. This takes into account the fact that small microcontrollers have only a few registers in which variables are stored on the processor. Each kernel element is loaded only once for two output pixels. Each data value is loaded only once for two output pixels. The specific implementation may be adapted to Cortex-M architecture. For other architectures with more registers, 3 or more pixels may be calculated in parallel, which further increases data reuse.

This pseudocode represents a procedure called “Interleaved Convolution 3×3, Stride 1”. It performs a convolution operation on a 3×3 kernel with a step of 1. This is an exemplary embodiment, for example the filter dimension, etc., can be changed as desired.

The method of FIG. 4 begins with initializing output variables o₀₀₀ and o₀₁₀ with the value b₀, which is zero, for example.

A loop is then started for each input channel c from 0 up to the total number of input channels. If only one channel is present, this loop may be left open.

Thereafter, a nested loop follows for each line r from 0 to 2, or up to the maximum number of filter coefficients of the filter (2) minus the value one. In the nested loop, the following steps are performed:
loading the data values d_{r0c}, d_{r1c} and the kernel element k_{r0c}.
calculating the value of o₀₀₀ by adding a product of d_{r0c} and k_{r0c} to a current value of o₀₀₀ and calculating the value of o₀₁₀ by adding a product of d_{r1c} and k_{r0c} to a current value of o₀₁₀.
loading the next kernel element k_{r1c}.
calculating the value of o₀₀₀ by adding a product of d_{r1c} and k_{r1c} to the current value o₀₀₀.
loading data values d_{r2c} and d_{r3c}.
calculating the value of o₀₁₀ by adding the product of d_{r2c} and k_{r1c} to the current value o₀₁₀.
loading the next kernel element k_{r2c}.
calculating the value of o₀₀₀ by adding the product of d_{r2c} and k_{r2c} to the current value of o₀₀₀ and calculating the value of o₀₁₀ by adding the product of d_{r3c} and k_{r2c} to the current value of o₀₁₀.

After the final step within the nested loop, either the nested loop for the next higher value for is r performed, or if r has reached its maximum value, the nested loop is terminated.

What has just been said regarding the termination of the nested loop applies analogously to the outer loop regarding the channels c.

After the procedure according to FIG. 4 has been performed, it may be performed again for the next receptive fields of the filter.

The embodiment described in FIG. 4 does not access the input data sequentially. For micro-controllers, this does not lead to run-time disadvantages. However, the machine code requires two pointers to run efficiently through the input data, which can limit the available registers. The same applies to the kernel elements. However, as the kernel elements are constant and are already known at the time of code generation, they can be reordered so that they are sequentially stored in memory. Instead of the old sequence k₀₀₀; k₀₀₁; :::; k₀₁₀; k₀₁₁; :::, the data is placed in the order k₀₀₀; k₀₁₀; k₀₂₀; ::: k₁₀₀; k₁₁₀; k₁₂₀; :::.

Microcontrollers with a DSP unit, such as Cortex-M4 and Cortex-M7, can execute two MAC instructions in parallel for quantized networks and can also load 4 bytes in parallel. For such architectures, the algorithm of FIG. 4 is modified so that two input channels are run in parallel. Correspondingly, the kernel reordering is then carried out with the elements from two channels in a row, e.g. k₀₀₀; k₀₀₁; k₀₁₀; k₀₁₁; k₀₂₀; k₀₂₁; :::.

Note that convolutions are also calculated in int8 networks with int16 variables to avoid overflows, i.e. two variables correspond to 4 bytes.

The implementation has been described in the case of (3×3) kernels with stride 1 and dilation 1. Among the kernel configurations commonly used in modern CNNs, this is the configuration that benefits the most. However, analogously, it can also be implemented for (3×3) cores with stride 2 and for (2×2) cores with stride 1 and also for exotic kernel configurations in which data is used multiple times. For each of the cases just mentioned, a different reordering of the kernel elements results accordingly.

What is claimed is:

1. A method for parallelized calculation of two convolutions of a filter having first and second receptive fields on input data, the first and second receptive fields correspond to the filter shifted by one step on the input data, the method comprising:
initializing first and second output variables (o₀₀₀,o₀₁₀) each having an initial value (b₀), wherein the output variables (o₀₀₀,o₀₁₀) each have a result of a convolution of the filter with the first and second receptive fields;
executing a loop for each line r of the filter, the loop performing:
loading a first kernel element (k_{r0c}) of the filter of the line r and corresponding data values d_{r0c}, d_{r1c} to the first kernel element k_{r0c} of the first and second receptive fields of the input data;
calculating a value of the first output variable (o₀₀₀) by adding a product of d_{r0c} and k_{r0c} to a current value of the first output variable (o₀₀₀), and calculating a value of the second output variable (o₀₁₀) by adding a product of d_{r1c} and k_{r0c} to a current value of the second output variable (o₀₁₀);
loading a kernel element (k_{r0c}) following the first kernel element (k_{r1c}) of the filter of the line r;
calculating the value of the first output variable (o₀₀₀) by adding a product of d_{r1c} and k_{r1c} to the current value of the first output variable (o₀₀₀);
loading the data values d_{r2c} and d_{r3c} following the data values d_{r0c}, d_{r1c} of the first and second receptive fields;
calculating the value of the second output variable (o₀₁₀) by adding a product of d_{r2c} and k_{r1c} to the current value of the second output variable (o₀₁₀);
loading a next kernel element k_{r2c} of the filter of the line r;
calculating the value of the first output variable (o₀₀₀) by adding a product of d_{r2c} and k_{r2c} to the current value of the first output variable (o₀₀₀), and calculating the value of the second output variable (o₀₁₀) by adding a product of d_{r3c} and k_{r2c} to the current value of the second output variable (o₀₁₀).

2. The method according to claim 1, wherein:
the filter and the input data have a plurality of channels, and
a further loop is executed for each channel across the loop over the lines.

3. The method according to claim 1, wherein:
the kernel elements have been read out line-by-line and the read-out lines are stored in a row as a sequence, and
the loading the kernel elements is performed from the sequence.

4. The method according to claim 2, wherein:
the method is performed by a data processing system,
the data processing system executes two MAC instructions simultaneously, and
two loops across the lines are executed for two channels simultaneously.

5. The method according to claim 1, wherein the filter comprises at least one 2×2 or 3×3 kernel.

6. The method according to claim 1, wherein the filter is a filter of a convolutional neural network.

7. The method according to claim 6, wherein the method is used to operate the convolutional neural network.

8. The method according to claim 1, wherein a computer program comprises instructions which, when the computer program is executed by a computer, prompt the computer to carry out the method.

9. A non-transitory machine-readable storage medium on which the computer program according to claim 8 is stored.

10. A device configured to carry out the method according to claim 1.
